(19) United States
(12) Patent Application Publication
(10) Pub. No.: US 2006/0139730 A1
(43) Pub. Date: Jun. 29, 2006

(54) Illumination system with compact turning prism and projection system using same

(76) Inventors: Peter R. Oehler, Aloha, OR (US); Bruce L. Cannon, Portland, OR (US); Sean M. Donnelly, Portland, OR (US)

Correspondence Address: 3M INNOVATIVE PROPERTIES COMPANY, PO BOX 33427, ST. PAUL, MN, 55133-3427, US

(21) Appl. No.: 11/022,445

(22) Filed: Dec. 23, 2004

(51) Int. Cl. G02B 26/00

(52) U.S. Cl. 359/291

(57) ABSTRACT

In a projection system, an illumination unit directs light to a spatial light modulator, via a prism having first, second and third sides. At least some of the illumination light from the illumination unit enters the prism through the first side, is totally internally reflected at the second side and exits the third side of the prism to the spatial light modulator. The illumination light is incident on the first side along a first axis, the first axis being directed with a component directed towards the spatial light modulator. In some cases, the first prism may introduce prism aberrations to the illumination light. The light from the illumination unit is directed tot the prism by light handling optics. The light handling optics compensate, at least in part, for the prism aberrations.

### FIELD OF THE INVENTION

The present invention is directed generally to systems for displaying information, and more particularly to projection systems and illumination systems that are used to illuminate spatial light modulators in the projection systems.

### BACKGROUND

Projection display systems use an illumination system to illuminate a spatial light modulator. The spatial light modulator imposes an image on the incident light, and the resulting image light is projected to a viewing screen. Spatial light modulators include liquid crystal display (LCD) panels and arrays of individually addressable, tiltable mirrors, often referred to as digital micromirror devices (DMDs). One popular form of DMD is the Digital Light Processor™, often referred to as DLP™, available from Texas Instruments DLP Product, Plano, Tex.

An important consideration in designing the optical system for illuminating the spatial light modulator is how to separate the incident illumination light from the image light beam reflected from the spatial light modulator. One approach for separating the illumination light from the image light, particularly useful when the image light is reflected from the spatial light modulator at an angle different from the incident angle of the illumination light, is to use a totally internally reflecting (TIR) prism for reflecting the illumination light, the image light, or both.

### SUMMARY OF THE INVENTION

One particular embodiment of the present invention is directed to an optical system that comprises an illumination unit capable of producing illumination light and a spatial light modulator comprising an array of rotatable mirrors lying in an imager plane. A first prism is disposed proximate the spatial light modulator, and has first, second and third sides. At least some of the illumination light from the illumination unit enters the first prism through the first side, is totally internally reflected at the second side and exits the third side of the first prism to the spatial light modulator. The illumination light is incident on the first side along a first axis, the first axis being directed with a component towards the imager plane.

Another embodiment of the present invention is directed to an optical system that comprises a spatial light modulator and a first prism disposed proximate the spatial light modulator, the first prism having first, second and third sides. Light handling optics directs illumination light to the first prism. At least some of the illumination light from the light handling optics enters the first prism through the first side of the first prism, is totally internally reflected at the second side and exits the third side of the first prism to the spatial light modulator. The first prism introduces prism aberrations to the illumination light and the light handling optics compensates, at least partly, for the prism aberrations.

Another embodiment of the present invention is directed to an illumination system for a spatial light modulator, comprising a digital micromirror device (DMD) spatial light modulator comprising an array of rotatable mirrors, the rotatable mirrors lying in an imager plane and being rotatable between respective first and second positions. The first position is associated with reflecting image light in a direction substantially perpendicular to the imager plane. A first prism is disposed proximate the spatial light modulator. The first prism has first, second and third sides. The first side forms an angle relative to the imager plane so that, when illumination light enters the first side of the first prism with a direction component directed towards the imager plane, the illumination light is totally internally reflected from the second side of the prism and exits the prism to the spatial light modulator at an angle so that image light is reflected from the rotatable mirrors in the first position in a direction substantially perpendicular to the imager plane.

The above summary of the present invention is not intended to describe each illustrated exemplary embodiment or every implementation of the present disclosure. The following figures and detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of part of a prior art illumination system for a spatial light modulator;

FIG. 2A schematically illustrates an embodiment of an equivalent prior art illumination system for a spatial light modulator;

FIG. 2B presents a footprint diagram resulting from ZEMAX™ modeling of the equivalent optical system shown in FIG. 2A;

FIG. 3 schematically illustrates a prior art projection system;

FIG. 4A schematically illustrates an embodiment of part of an embodiment of an illumination system for a spatial light modulator according to principles of the present invention;

FIG. 4B presents a simplified version of the prior art illumination system of FIG. 1;

FIGS. 4C-4E schematically present additional embodiments of illumination systems according to principles of the present invention;

FIG. 5 schematically illustrates an embodiment of a projection system according to principles of the present invention;

FIG. 6A schematically illustrates another embodiment of a projection system according to principles of the present invention;

FIG. 6B schematically illustrates an equivalent optical system used for ZEMAX™ modeling the exemplary projection system of FIG. 6A;

FIG. 6C presents a footprint diagram resulting from ZEMAX™ modeling the equivalent optical system shown in FIG. 6B;

FIG. 7A schematically illustrates another equivalent optical system used for Zemax™ modeling another exemplary embodiment of an illumination system according to principles of the present invention;

FIG. 7B presents a footprint diagram resulting from ZEMAX™ modeling the equivalent optical system shown in FIG. 7A; and

FIGS. 8 and 9 schematically illustrate other embodiments of part of an embodiment of an illumination system for a spatial light modulator according to principles of the present invention.

While the invention is amenable to various modifications and alternative forms, specifics thereof have been shown by way of example in the drawings and will be described in detail. It should be understood, however, that the invention is not limited to the particular exemplary embodiments described herein. On the contrary, the intention is to cover all modifications, equivalents, and alternatives falling within the spirit and scope of the disclosure as defined by the appended claims.

### DETAILED DESCRIPTION

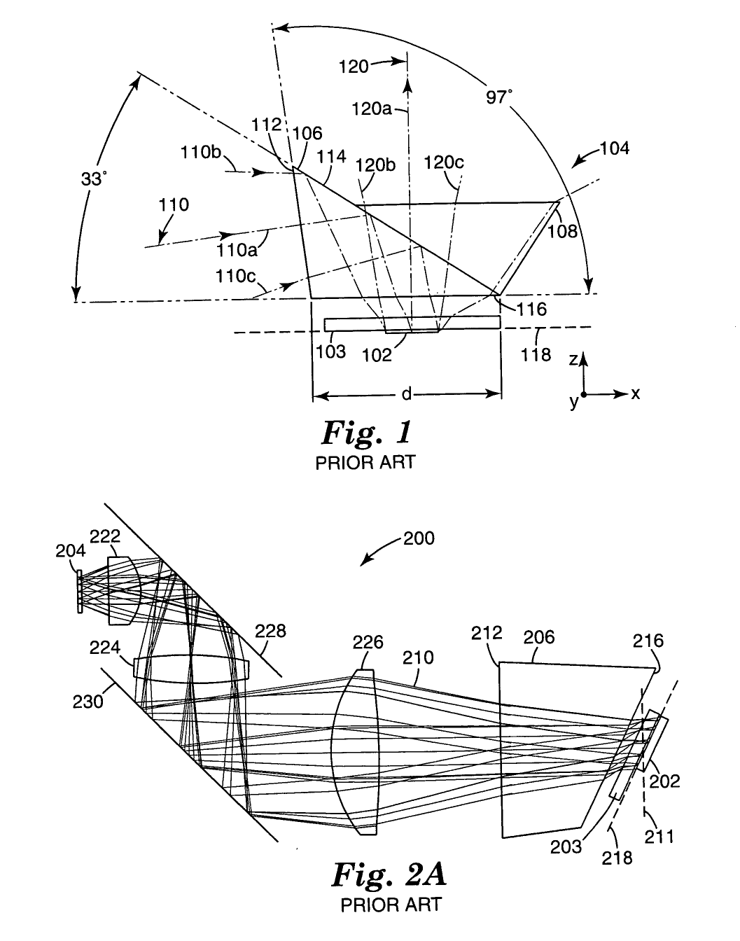

A conventional approach for illuminating a digital micromirror device (DMD)-type spatial light modulator 102 is schematically illustrated in FIG. 1. A prism unit 104 is disposed over the spatial light modulator 102. The spatial light modulator 102 is often provided with a cover plate 103 for protection. The prism unit 104 includes a first prism 106 and a second prism 108. The illumination light 110 enters the first side 112 of the first prism 106, is totally internally reflected at the second side 114 of the first prism 106, and exits the first prism 106 through the third side 116, and is incident on the spatial light modulator 102. The illumination light 110 is shown represented by its gut ray 110a (central, or axial, ray), and the two marginal rays 110b, 110c. When incident on the first surface 112 of the prism 106, the gut ray 110a is propagating with an upwards component, i.e. with a component in the positive z-direction. In the following description, when light is described as propagating in a particulardirection, it should be understood that the particular direction is followed by the central ray, or gut ray, of the light. Thus, light that is diverging or converging may be said to propagate along the direction of its gut ray.

Right-handed Cartesian axes have been adopted to aid in the following description. The orientation of the axes is, however, arbitrary, and different orientations may be used in describing the invention.

The first prism 106 is sized so that the illumination light is not vignetted. The sides 112, 114, 116 of the first prism 106 are typically anti-reflection coated, and so the sides 112, 114, 116 allow for a small space between the marginal rays 110b, 110c and the edge of the prism 106 to allow for the coating rails used to support the prism 106 during the coating process.

The overall length of the third side 116, in the x-direction, is determined by the requirement to have the illumination light 110 centered on the spatial light modulator 102 without vignetting. For HD-3 and xHD-3 DMD-type spatial light modulators, produced by Texas Instruments, Plano, Tex., the minimum value of the length, d, of the third side 116 is about 45 mm, while the second side 114, has a length of about 58 mm.

For many DMD-type spatial light modulators, such as the HD-3 and xHD-3 devices, the mirrors tilt at ±12° about a flat position. The flat position is parallel to the imager plane 118. The imager plane 118 is shown in FIG. 1 as being parallel to the x-y plane, where the y-direction is into the plane of the figure. The mirrors of the DMD display device are arranged in a plane: the imager plane 118 is located at the plane in which the mirrors are arranged. The spatial light modulator 102 reflects image light 120 in a direction that is approximately perpendicular to the imager plane 118. The image light 120 is represented by its gut ray 120a, and two marginal rays 120b, 120c. Accordingly, the illumination light 110 is incident at the imager plane 118 at angles typically in the range 24°-27°, with 26° being a commonly selected value. In conventional projection systems, the first prism 106 is commonly designed with its second side 114 lying at approximately 330 to the third side 116, and with the first side 112 lying at approximately 97° to the third side 116. This arrangement allows for clean separation of the illumination light 110 and the image light 120 when illuminating the spatial light modulator 102 at an incident angle of 26°. Additionally, the illumination light 110 is incident on the first side 112 approximately perpendicularly.

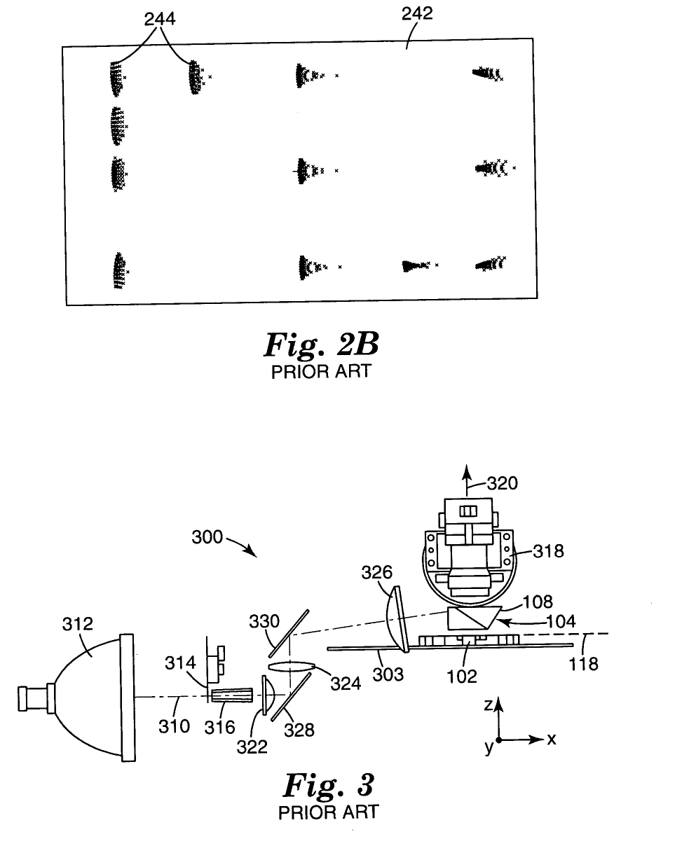

A schematic diagram of part of a conventional illumination system 200, using the first prism 106 is shown in FIG. 2A. The illumination light 110 propagates along a folded optical path through the first prism 106 that is effectively the unfolded path through a wedge element, where the wedge is represented by unfolding the first prism across the second side 114, where total internal reflection occurs. Thus, the first prism 106 is represented as a wedge 206 with the illumination light 210 entering the wedge through a first surface 212, equivalent to the first side 112 of the first prism 106, and exiting the wedge 206 through the second surface 216, equivalent to the third side of the prism 106.

In this system, illumination light 210 passes from an object plane 204, the output aperture of a tunnel integrator, passes through three lenses 222, 224, 226, and is folded at two folding mirrors 228, 230, before reaching the wedge 206. The light 210 passes through the wedge 206 to the spatial light modulator 202 through a cover glass 203.

Although the illumination light 210 is normally incident on the first surface 212 of the wedge 206, the light 210 passes out of the wedge 206 at an angle through the second surface 216. Consequently, the illumination light 210 is aberrated upon reaching the spatial light modulator 202. This can be seen in the footprint diagram of FIG. 2B, generated by a commercially available ray tracing program, Zemax™, which shows an equivalent area 242 of the spatial light modulator 202 at the imager plane 218 and various illuminated spots 244 within the equivalent area at the imager plane 218. The spots 244 represent the images of various equivalent point sources placed at different positions across the object 204. The area 242 has dimensions of 18 mm×10 mm. A selection of the spots 244a-244f is presented in FIG. 2C, showing the spots 244a-244f each within a standard 2 mm×2 mm area 246.

The spots 244 are severely aberrated, resulting in poor focus of the illumination light at the imager plane 218. It is believed that the illumination light 210 incident at the imager plane 218 suffers from, inter alia, astigmatism and/or coma in the illumination light 210 that results from passing through the wedge 206. Also, since the illumination light 210 passes through the second surface 216 at an angle, there is some color separation of the illumination light at the imager plane 218 due to dispersion. These aberrations are referred to as prism aberrations since they are introduced by the TIR prism. In addition, the illumination light 210 has a focal plane 211 that is tilted relative to the imager plane 218, and so the illumination light 210 is in focus at the spatial light modulator 202 only where the focal plane 211 intersects the imager plane 218, along one line across the imager plane 218, and remains out of focus elsewhere on the imager plane 218. As a result of these aberrations, the illumination system 200 must overfill the spatial light modulator 202 with illumination light 210 in order to ensure uniform illumination intensity over the spatial light modulator 202 for all colors. This results in a loss of illumination efficiency, since some of the illumination light 210 is necessarily lost around the edges of the spatial light modulator 202.

The architecture of this illumination system also presents some packaging difficulties, as is schematically illustrated for the projection system 300 in FIG. 3. The spatial light modulator 102 is mounted on a Formatter Electronics Circuit Board (FECB) 303. The illumination light 310 is generated by a light source 312. The illumination light 310 passes through a color wheel 314 and a tunnel integrator 316. After passing out of the tunnel integrator 316, the illumination light is relayed by three lenses 322, 324, 326 and two folding mirrors 328, 330 to the spatial light modulator 102. A prism unit 104, formed by the first and second prisms 106, 108, sits above the spatial light modulator 102. The illumination light 310 totally internally reflects within the first prism 106 to the spatial light modulator 102. Image light 320 is reflected from the spatial light modulator 102 and through a projection lens unit 318.

The gut ray of the illumination light 310 propagates with a component in the positive z-direction when it reaches the first prism 106. In the example illustrated in FIGS. 1 and 3, the illumination light 310 has an upwards component in the positive z-direction, angled at 7° from parallel to the x-y plane. Thus, the illumination light 310 propagates with a direction component directed away from the imager plane 118. When the illumination light 310 propagates with a direction component away from the imager plane 118, there may exist a problem of the illumination light 310 interfering with the FECB 303. Also, any light handling optics, for example relay lenses between the integrator 316 and the spatial light modulator 102, may interfere with the FECB 303. In the illustrated exemplary embodiment, the third relay lens 326 interferes with the FECB 303.

To reduce the problem of interference, practical optical engines using such a spatial light modulator 102 may include an additional folding mirror in the illumination light path in close proximity to the first prism 106. This permits the system designers to fold the light away from the FECB 303 and preserve a compact package. Furthermore, it is convenient to have an accessible illumination aperture stop to control stray light and improve contrast. Thus, when the folds and aperture stop are introduced to the illumination light path, and the aperture stop is inserted to the light path, a relatively long illumination path is required. This is most commonly realized with three or four relay lenses, in addition to the two folds.

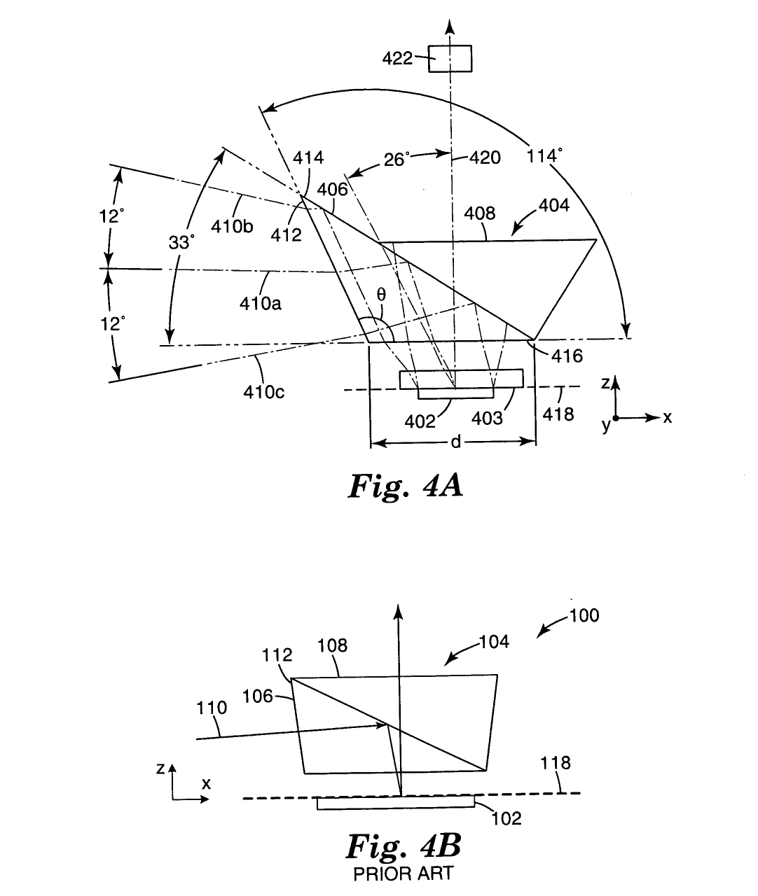

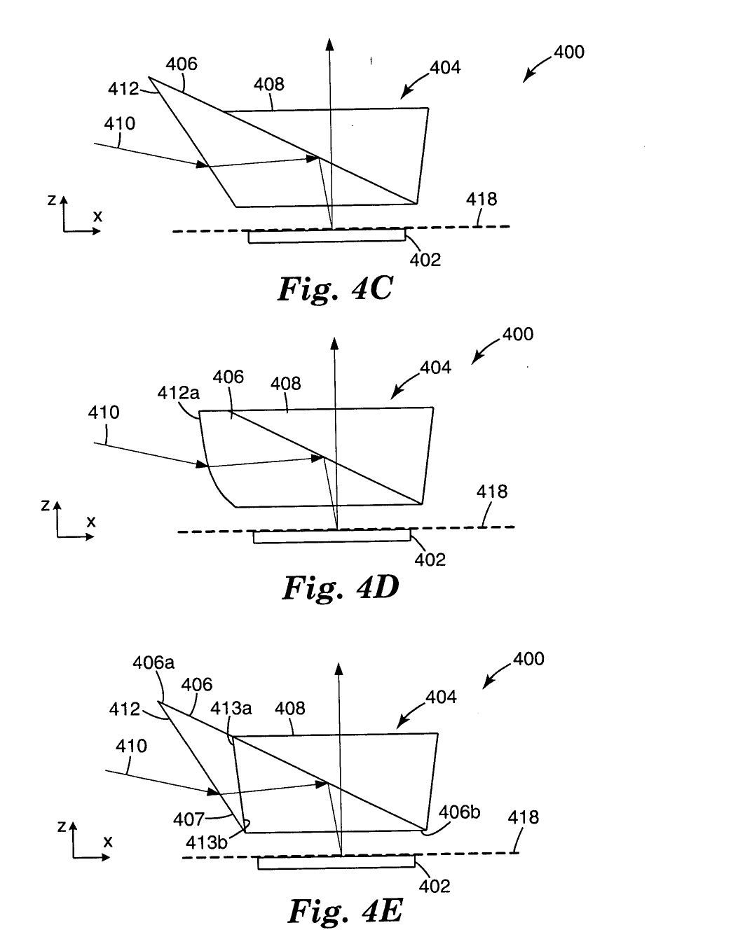

Part of one particular embodiment of an illumination system 400 that reduces the effects of these problems is schematically illustrated in FIG. 4A. In this exemplary embodiment, prism unit 404 is provided proximate a spatial light modulator 402. The spatial light modulator 402 is shown as a DMD-type spatial light modulator, having rotatable mirror modulator elements disposed in an imager plane. The prism unit 404 may be used with other types of spatial light modulators, however, such as a reflective or transmissive liquid crystal display (LCD) imager device. The illumination light incident on the spatial light modulator and the image light from the spatial light modulator may propagate along different, non-parallel directions, or may propagate along parallel directions. The imager plane 418 of the spatial light modulator 402 is the plane where the modulating elements of the spatial light modulator are located. For example, in the case of a DMD-type spatial light modulator, the imager plane 418 is a plane containing the micromirrors in their flat, unactuated positions. In the case of a liquid crystal spatial light modulator, the imager plane is a plane containing the liquid crystal modulator elements.

The prism unit 404 comprises a first prism 406, which totally internally reflects incoming illumination light 410 and a second prism 408. The illumination light 410 is represented by a gut ray 410a, also referred to as the central or axial ray, and marginal rays 410b, 410c. When the illumination light is described as propagating along an axis, the gut ray 410a is coincident with that axis. The illumination light 410 is incident on the first side 412 of the prism 406, is totally internally reflected at the second side 414 of the prism 406 and passes out of the third side 416 of the prism 406 to the spatial light modulator 402. The third side 416 may be parallel to the imager plane 418, which is parallel to the x-y plane in the figure. The y-direction lies in a direction into the plane of the figure. The illumination light 410 may pass through a cover glass 403 before being incident on the spatial light modulator 402.

The image light 420, propagating from the spatial light modulator 402, is transmitted through the third and second sides 416, 414 of the first prism 406, and to the second prism 408. The image light 420 may be transmitted through the second prism 408 to a projection lens unit 422, as illustrated or, in another configuration (not shown), may be internally reflected by the second prism 408 to the projection lens unit 422.

The illumination light 410 is incident at the first side 412 of the first prism 406 at an angle other than normal incidence. In other words, the illumination light 410 propagates along an axis, coincident with the gut ray 410a, that is non-normal to the first prism side 412. Thus, the illumination gut ray 410a changes direction on entering the first prism 406. In the illustrated embodiment, the interior angle, θ₁, between the first side 412 and the third side 416 is 114°, and the illumination gut ray 410a is tilted downwards, in the negative z-direction at an angle of 2°. Therefore, the gut ray 410 is incident on the first side 412 at an angle of 26° from the normal to the first side 412. The angles shown in FIG. 4 are provided as examples only, and other values of inter-face angles may be used.

The increase in the interior angle, θ₁, between the first and third faces 412, 416 has a number of beneficial effects. First, in some embodiments, the size of the first prism can be smaller than that in the case illustrated in FIG. 1. For example, for illumination of an HD-3, or xHD-3 type Texas Instrument DMD-type spatial light modulator, the length of the third side 416 is 27.5 mm for the particular embodiment illustrated in FIG. 4, and the length of the second side 414, where TIR takes place, is 46 mm. This is substantially smaller than the prior art case shown in FIG. 1, where the third side 116 had a length of 45 mm and the second side 114 had a length of 58 mm. The reduction in prism size results in a reduction in the coated surface area, with a concomitant reduction in manufacturing costs.

Second, in some embodiments, the gut ray 410a of the illumination light 410 is propagating in a direction that has a component in the negative z-direction when incident on the prism 406. Thus, the illumination light 410 may be said to have a propagation component that is directed towards the imager plane 418 when incident on the first prism 406. This reduces the possibility of interference between the illumination light 410 and any FECB to which the spatial light modulator 402 is mounted. This effect may be better understood with reference to FIGS. 4B-4D, which show different types of prisms. FIG. 4B schematically illustrates the prior art illumination system of FIG. 1, where a prism unit 104, formed of two prisms 106 and 108, is disposed over a spatial light modulator 102. The illumination light 110 is incident on the first side 112 of the first prism 106, in a direction that includes a component along the positive z-direction, i.e. in a direction away from the imager plane 118.

FIG. 4C schematically illustrates a simplified version of FIG. 4A, showing that the illumination light 410 is incident on the first side 412 of the first prism 406 in a direction towards the imager plane 418. FIG. 4D schematically illustrates another exemplary embodiment of the illumination system 400, in which the first prism 406 has a curved first side 412a. The curved first side 412a may be polished on the first prism 406. The curved first side 412a manifests optical power, i.e. changes the divergence of the illumination light 410 passing therethrough. The curved first side 412a may comprise part of an optical relay system that relays the illumination light 410 to the spatial light modulator 402.

The first prism 406 may be formed from a single component or may be formed from multiple components. An exemplary embodiment showing the first prism formed from two components 406a, 406b is schematically illustrated in FIG. 4E. The prism components 406a and 406b may be attached using any suitable method that permits the illumination light to pass from the component 406a to the component 406b, for example, optical adhesive or optical epoxy, or optical bond between two flat, polished surfaces. In one particular exemplary embodiment, the illumination light 410 may be refracted by the component 406a so as to pass perpendicularly through the interface between the two components 406a, 406b, as illustrated. The entrance surface 407 of the first components 406a may be flat, as illustrated, or may be curved, for example like side 412a in FIG. 4D. The interfacial sides 413a, 413b of the components 406a, 406b may be, but are not required to be, flat. There may be a gap between the interfacial sides 413a, 413b. The gap may be filled with air, adhesive or some other material.

In some exemplary embodiments, the illumination system may be designed to reduce the prism aberrations introduced to the illumination light by the first prism, and to tilt the focal plane of the illumination light so that the tilt of the focal plane is more parallel to the imager plane. One particular approach is to use a reflective integrator whose output aperture does not lie parallel to the input aperture. Such integrators are referred to herein as non-parallel apertured (NPA) reflective integrators, and are described in greater detail in co-owned U.S. patent application Ser. No. 10/744,994, incorporated herein by reference.

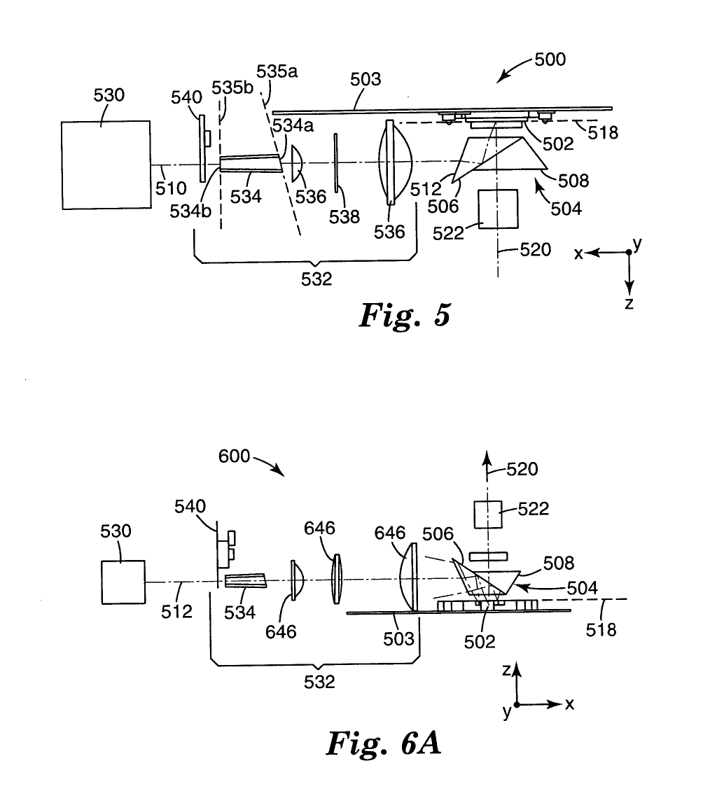

One exemplary embodiment of an illumination system 500 that includes an NPA reflective integrator is schematically illustrated in FIG. 5. Illumination light 510 from a light source 530 is directed via light handling optics 532 to the prism unit 504 that has first and second prisms 506, 508. The illumination light 510 is totally internally reflected within the first prism 506 and is directed to the spatial light modulator 502. The image light 520 passes through a projection lens unit 522 and is projected to a screen (not shown) for viewing.

The light source 530 that generates the illumination light 510 may be any suitable type of light source. For example, in some embodiments, the light source 530 may include a high-pressure mercury arc lamp, as is commonly used with color projection systems. In other embodiments, the light source may include other types of lamps, semiconducting light sources such as light emitting diodes (LEDs), organic light emitting diodes or lasers, or other light generators. The light source 530 may also be integrated with some optical elements for collecting and directing the illumination light. For example, high-pressure mercury arc lamps are often integrated with a parabolic or elliptical reflector. In other examples, LEDs are often supplied with lenses or other forms of light collectors.

The light handling optics 532 comprises an arrangement of optical elements that direct the illumination light 510 emitted from the light source 530 to the prism unit 504. The light handling optics 532 may comprise, for example, a reflective integrator 534, one or more relay lenses 536, and one or more apertures 538. The reflective integrator 534 is an element that has reflecting walls disposed parallel to, or generally along, the direction of the illumination light 510. The illumination light 510 enters the reflective integrator 534 and experiences a number of reflections off the reflecting walls so that when the light emerges at the output aperture 534a, the intensity profile across the illumination light beam 510 is substantially uniform. The reflective integrator 534 may have parallel reflecting walls, or some of the reflecting walls may be non-parallel, so that the reflective integrator is tapered, or otherwise has a cross-section that is non-uniform along the length of the integrator 534. In some embodiments, the reflective integrator 534 may be solid, as with a solid rod integrator, in which case the illumination light 510 internally reflects at the reflecting walls, and may totally internally reflect at the reflecting walls. In other embodiments, the reflective integrator 534 may be hollow, often referred to as a hollow tunnel integrator, with the hollow space surrounded by reflectors. In the illustrated exemplary embodiment, the reflective integrator 534 is an NPA reflective integrator, and has non-parallel sidewalls. The output aperture 534a lies in an output aperture plane 535a. Also, the input aperture 534b of the integrator 534 lies in an input aperture plane 535b that is not parallel to the output aperture plane 535a.

In some embodiments, the output aperture 534a of the reflective integrator 534 is substantially imaged by the relay lenses 536 at the imager plane 518. This increases the amount of illumination light incident at the spatial light modulator 502. The input face 512 of the first prism 506 may be part of the image relay system if the input face 512 of the first prism 506 is curved or otherwise provided with optical power.

The light handling optics 532 may also include a device for controlling the color of the light 510 incident at the spatial light modulator 502. For example, where the light source 530 produces white light, a color filter 540, such as a color wheel or the like, may be used to provide a sequence of colors, e.g. when the spatial light modulator 502 is operated in a field sequential color mode. In other embodiments, the light source 530 itself may produce an illumination light beam 510 of sequentially varying color.

The light handling optics 532 may include other optical elements, for example, folding mirrors, polarization control elements such as polarizers and polarization converters, color control elements such as dichroic filters or scrolling prisms, and apertures and stops, and the like.

In some embodiments, the illumination light 510 propagates in a direction towards the imager plane 518, and so the problem of interference by the FECB 503 may be reduced.

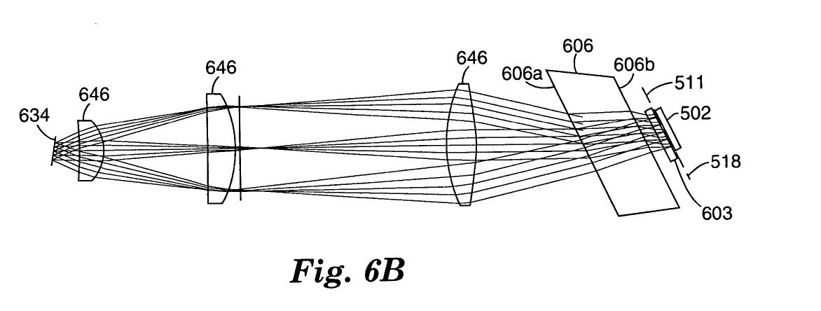

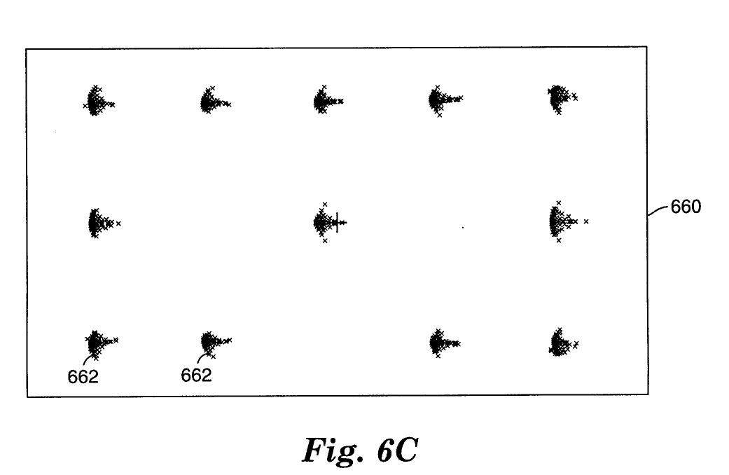

Another exemplary embodiment of an illumination system 600 is schematically illustrated in FIG. 6A. In this particular embodiment, the light handling optics 532 includes three relay lenses 646. It will be appreciated that variations on the illumination system 600 may be used. For example, an illumination system may include one or more folding mirrors, or a different number of relay lenses.

A schematic diagram of an equivalent optical system 650 to the illumination system 600 is shown in FIG. 6B, in which the TIR prism 506 is replaced by the equivalent transmissive wedged element 606. The illumination light 510 is imaged from the object plane 634 to the imager plane 518. In some exemplary embodiments, the object plane 634 is taken as the output aperture 534a of the reflective integrator 534. Where the reflective integrator 534 is an NPA integrator, the object plane 634 is tilted from being perpendicular to the axis of the illumination light 510. The illustrated equivalent system 650 follows illumination light 510 only as far as the imager plane 518, so the second prism 508 and projection lens unit 522 are omitted from the equivalent system 650.

The wedged element 606 has a significantly smaller wedge angle than the wedged element 206 and may, in some embodiments, have parallel surfaces 606a, 606b. Parallel surfaces 606a, 606b are equivalent to embodiments where the angle between the first prism side and the entering illumination light is the same as the angle between the third prism side and the exiting illumination light 510. The light 510 transmitted through the equivalent wedged element 606 may be transmitted through a cover glass 603 before incidence on the spatial light modulator 502.

The NPA reflective integrator 534, was assumed to be a tunnel integrator having a length of approximately 30 mm and an output aperture of approximately 4.5 mm×8 mm. The tunnel integrator was tapered, having an input aperture of 4.5 mm×6 mm. The input aperture plane of the tunnel integrator was perpendicular to the axis of the tunnel integrator, while the output aperture was tilted at an angle of about 18.5° relative to being perpendicular to the tunnel integrator axis.

The equivalent optical system 650 has been modeled using Zemax to compare the aberrations in the illumination light incident at the image plane with the aberrations of the conventional system 200. A footprint diagram, showing a number of spots 662 on an equivalent imager area 660 is presented in FIG. 6C. The equivalent imager area 660 is the same size as the area 242 in FIG. 2B. As can be seen, the spots 662 are smaller than those in FIG. 2B, showing that the equivalent illumination system 650 has reduced the aberrations present in the system of FIG. 2A.

Thus, even though the light 510 passes non-perpendicularly through two surfaces of the first prism 506, the aberrations in the illumination light 510 are reduced below those of the conventional system by introducing an NPA integrator element that compensates, at least in part, for the prism aberrations. Furthermore, the tilted object plane 634 results in a tilt in the focal plane 511 of the illumination light 510 towards the imager plane 518. In other words, the angle between the focal plane 511 and the imager plane 518 is reduced, and so the illumination light 510 is in focus over an increased portion of the spatial light modulator 502. In the drawing, the focal plane 511 is shown as being coincident with the imager plane 518, although this is not a necessary condition.

The resultant ability to better control the focus of the illumination light at the spatial light modulator 502 permits the amount of overfill to be reduced, with the result that the illumination light 510 is incident on the spatial light modulator 502 with a greater intensity.

Another approach to compensating for the aberrations involves tilting or translating one or more of the relay lenses that relay illumination light to the spatial light modulator. When a lens is described as being tilted, the optical axis of that lens is not parallel to the gut ray of the illumination light. When a lens is described as being translated, the gut ray does not pass through that lens at the optical axis. This approach may be used to provide compensation to the aberrations even if the input and output ends of the reflective integrator are parallel.

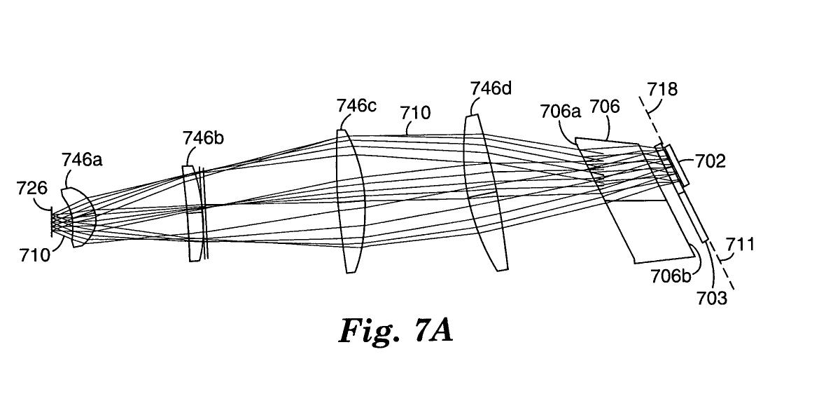

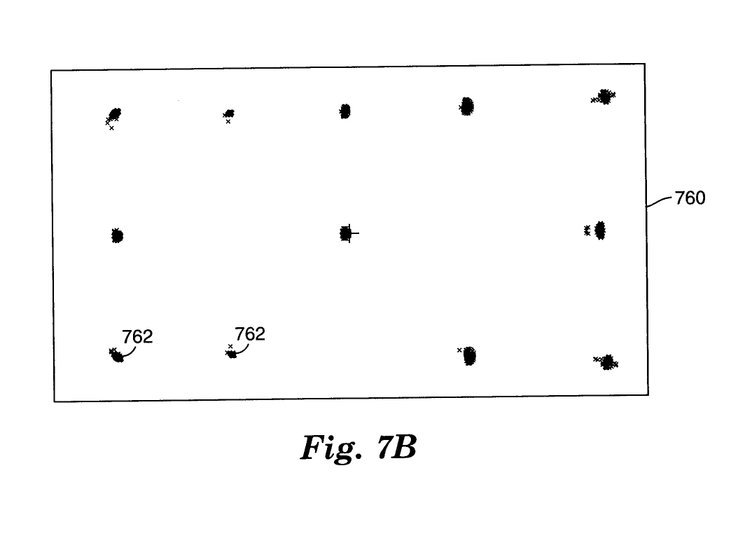

An exemplary embodiment of this approach is described with reference to FIG. 7A, which shows an optically equivalent illumination system 700 with illumination light 710 propagating from an object plane 724 to a spatial light modulator 702 via a series of relay lenses 746a, 746b, 746c, 746d and an equivalent wedged element 706. The object plane 724 may represent, for example, the output aperture of a reflective integrator. The wedged element 706 is a transmissive equivalent to the reflectively folded TIR prism used in an actual illumination system. The illumination light 710 illuminates the spatial light modulator 702, which is placed behind a cover plate 703. The spatial light modulator 702 lies on, and is parallel to, the imager plane 718.

In this exemplary embodiment, the object plane 724 is assumed to be the output aperture of a conventional reflective integrator, in which the output aperture defines a plane that is perpendicular to the axis of the illumination light 510. The walls of the reflective integrator may lie parallel to the longitudinal axis of the integrator, or one or more of the integrator walls may be nonparallel to the integrator's axis, for example as in a tapered integrator as described in U.S. Pat. No. 5,625,738, incorporated herein by reference.

One or more of the lenses 746a, 746b, 746c and 746d may be translated and/or tilted relative to the illumination light 710. In the particular embodiment illustrated in FIG. 7A, each of the lenses 746a, 746b, 746c, 746d is both translated and tilted: this configuration was shown using Zemax™ modeling to provide significant compensation for the prism aberrations. It will be appreciated that the number of relay lenses used between the reflective integrator and the spatial light modulator may be different from four, and that the different lenses may be translated and/or tilted relative to the illumination light through a different degree, depending on the desired amount of aberration compensation.

The equivalent optical system 700 was modeled using a Zemax™ ray tracing program to compare the aberrations in the illumination light 710 incident at the imager plane 718 with the aberrations produced by the conventional system 200. A footprint diagram, showing a number of spots 762 on an equivalent imager area 760, sized 18 mm×10 mm, is presented in FIG. 7B. The equivalent imager area 760 is the same size as the area 242 in FIG. 2B. As can be seen, the spots 762 are generally smaller than those in FIG. 2B, showing that the equivalent illumination system 700 has significantly reduced the aberrations in the illumination light 710 incident at the imager plane. The tilted/translated lenses result in a tilt in the focal plane 711 of the illumination light 710 towards the imager plane 718. In other words, the angle between the focal plane 711 and the imager plane 718 is reduced, and so the illumination light 710 is in focus over a larger portion of the spatial light modulator 702. In the drawing, the focal plane 711 is shown as being coincident with the imager plane 718.

Thus, the aberrations in the illumination light 710 incident at the imager plane 718, including the problems arising from a tilted illumination target and prism aberrations introduced by the two non-normal surfaces 706a, 706b of the equivalent wedged element 706, are compensated, at least in part, by introducing translation and tilt to the one or more of the relay lenses that image the illumination light 710 on to the spatial light modulator 702. The designer is afforded significant latitude in the design of such an illumination system since there are two degrees of freedom, translation and tilt, for each relay lens. The resultant ability to control the focus of the illumination light 710 better at the spatial light modulator 702 permits the amount of overfill to be reduced, with the result that the illumination light 710 is incident with a greater intensity on the spatial light modulator 702.

The use of an NPA reflective integrator and the use of translated/tilted lenses have been described separately to illustrate that different approaches to compensating for the prism aberrations are available. These different approaches may be used together, however, in a single system that combines an NPA reflective integrator with lens translation and/or tilt to provide compensation for prism aberrations arising in the TIR prism.

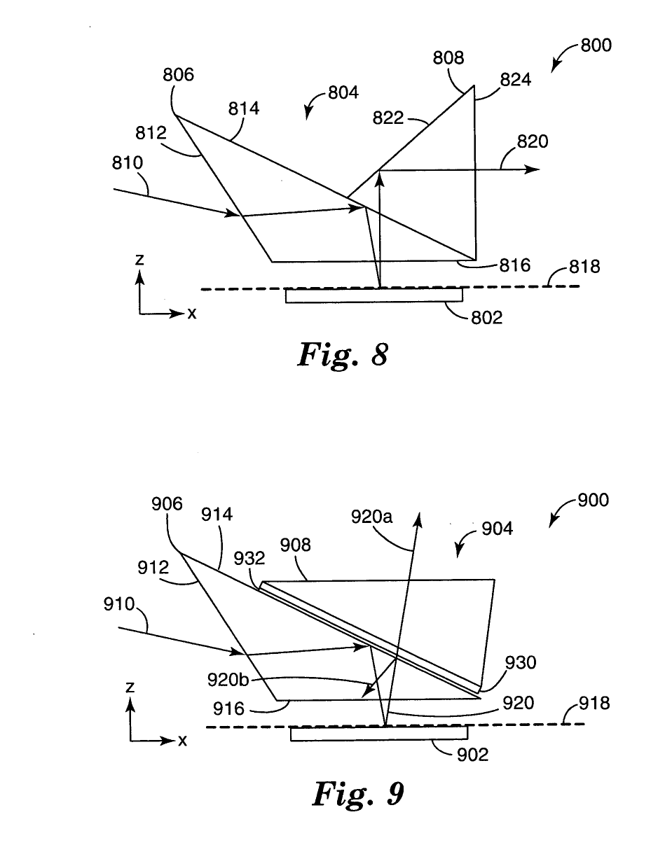

In some embodiments, for example as shown in FIG. 4A, image light is transmitted through the second prism. In other exemplary embodiments, for example system 800 schematically illustrated in FIG. 8, the image light may be reflected by the second prism. The system 800 includes a spatial light modulator 802 that defines an imager plane 818, and a prism unit 804 disposed close to the spatial light modulator 802. The prism unit 804 includes two prisms 806, 808. The first prism 806 has a first side 812, a second side 814 and a third side 816. Illumination light 810 from a light source (not shown) enters the first side 812 of the first prism 806, is totally internally reflected from the second side 814 of the first prism 806, and passes through the third side 816 of the first prism 806 to the spatial light modulator 802. Image light 820 from the spatial light modulator 802 passes through the third and second sides 816, 814 of the first prism 806 into the second prism 808, is reflected at the second side 822 of the second prism 808, and exits through the third side 824 of the second prism 808. The image light 820 may then pass to a projection lens unit (not shown) for projection on a screen.

In some exemplary embodiments, the prism unit may include polarization control elements, for example a reflective polarizer. One particular exemplary embodiment of a prism unit that includes a polarization control element is schematically illustrated in FIG. 9. The illumination system 900 includes a spatial light modulator 902 that defines an imager plane 918, and a prism unit 904 disposed close to the spatial light modulator 902. The prism unit 904 includes two prisms 906, 908 and a polarization control element 930 between the two prisms 906, 908. The polarization control element 930 may be, for example, a polarizer such as a reflective polarizer. The first prism 906 has a first side 912, a second side 914 and a third side 916. Illumination light 910 from a light source (not shown) enters the first side 912 of the first prism 906, is totally internally reflected from the second side 914 of the first prism 906, and passes through the third side 916 of the first prism 906 to the spatial light modulator 902.

Modulated light 920 from the spatial light modulator passes through the third and second sides 916, 914 of the first prism 906. The modulated light 920 may propagate from the spatial light modulator 902 in a direction non-perpendicular to the imager plane 918, as illustrated, or may propagate from the spatial light modulator 902 in a direction perpendicular to the imager plane 918. At least some of the modulated light 920 passes through the polarization control element 930 as image light 920a into the second prism 908, and passes out of the second prism 908. The image light 920a may be transmitted through the second prism 908 or may be reflected within the second prism 908. Where the polarization control element 930 is a reflective polarizer, the image light 920a is the image light that exists in the pass polarization state of the polarizer. Some of the reflected light 920, in the block polarization state of the polarizer, may be reflected as blocked light 920b and does not pass into the second prism 908.

In some exemplary embodiments, there may be a gap 932 between the polarization control element 930 and the second side 914 of the first prism 906 so as to permit the illumination light 910 to totally internally reflect at the second side 914 of the first prism. The polarization control element 930 may be attached to the second prism 908, or there may be a gap between the polarization control element and the second prism 908. In other exemplary embodiments, the polarization control element 930 may be attached to the second side 914 of the first prism 906.

As noted above, the present disclosure is related to display devices, and is believed to be particularly useful for inexpensive, high brightness, image projection systems. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An optical system, comprising:
an illumination unit capable of producing illumination light;
a spatial light modulator comprising an array of rotatable mirrors lying in an imager plane; and
a first prism disposed proximate the spatial light modulator, the first prism having first, second and third sides, at least some of the illumination light from the illumination unit entering the first prism through the first side, being totally internally reflected at the second side and exiting the third side of the first prism to the spatial light modulator, the illumination light being incident on the first side along a first axis, the first axis being directed with a component towards the imager plane.

2. A system as recited in claim 1, wherein the third side of the first prism is substantially perpendicular to a direction of image light propagating from the spatial light modulator.

3. A system as recited in claim 1, wherein the first axis is non-perpendicular to the first side of the first prism.

4. A system as recited in claim 1, further comprising a second prism disposed proximate the first prism, the first and second prisms forming a prism unit, image light from the spatial light modulator passing through the third and second sides of the first prism to the second prism.

5. A system as recited in claim 4, wherein the image light is transmitted through the second prism.

6. A system as recited in claim 4, wherein the image light is reflected within the second prism.

7. A system as recited in claim 4, further comprising a polarization control element disposed between the first and second prisms.

8. A system as recited in claim 1, further comprising a projection lens unit, image light from the spatial light modulator being projected by the projection lens unit.

9. A system as recited in claim 1, wherein the illumination unit comprises at least one light source capable of generating the illumination light, and light handling optics for handling the illumination light between the at least one light source and the first prism.

10. A system as recited in claim 9, wherein the at least one light source comprises a reflective integrator, light from the at least one light source being focused into an input end of the reflective integrator.

11. A system as recited in claim 10, wherein the first prism introduces prism aberrations to illumination light passing through the first prism and the light handling optics compensates, at least partly, for the prism aberrations.

12. A system as recited in claim 11, wherein the light handling optics comprises one or more lenses disposed on an optical path of the illumination light between the reflective integrator and the first prism, at least one of the one or more lenses being i) translated, ii) tilted, or iii) translated and tilted relative to the illumination light.

13. A system as recited in claim 12, wherein the light handling optics comprises at least two lenses, at least two of the at least two lenses being i) translated, ii) tilted or iii) translated and tilted to the illumination light.

14. A system as recited in claim 11, wherein the reflective integrator compensates, at least partly, for the prism aberrations.

15. A system as recited in claim 14, wherein the reflective integrator has an input aperture at the input end, the input aperture being defined by input aperture sides, the input aperture sides lying in an input plane, and the reflective integrator has an output aperture defined by output aperture sides, at least one of the output aperture sides being non-parallel to the input plane.

16. A system as recited in claim 1, wherein the first side of the first prism has optical power, the divergence of the illumination light being changed upon passing through the first side of the first prism.

17. A system as recited in claim 1, wherein the first prism is formed of at least a first component and a second component.

18. An optical system, comprising:
a spatial light modulator;
a first prism disposed proximate the spatial light modulator, the first prism having first, second and third sides; and
light handling optics for directing illumination light to the first prism, at least some of the illumination light from the light handling optics entering the first prism through the first side of the first prism, being totally internally reflected at the second side and exiting the third side of the first prism to the spatial light modulator, the first prism introducing prism aberrations to the illumination light and the light handling optics compensating, at least partly, for the prism aberrations.

19. A system as recited in claim 18, wherein the spatial light modulator has modulator elements lying in an imager plane, illumination light is non-perpendicularly incident on the spatial light modulator at the imager plane, and the light handling optics tilts a focal plane of the illumination light towards the imager plane.

20. A system as recited in claim 18, wherein the spatial light modulator comprises an array of mirrors rotatable between first and second positions.

21. A system as recited in claim 18, wherein the illumination light enters the first side of the first prism in a direction non-perpendicular to the first side of the first prism.

22. A system as recited in claim 18, wherein the light handling optics comprises at least one lens disposed on an optical path of the illumination light, the at least one lens compensating, at least partly, for the prism aberrations.

23. A system as recited in claim 22, wherein the at least one lens comprises at least one lens that is i) tilted, ii) translated or iii) tilted and translated relative to the illumination light.

24. A system as recited in claim 22, wherein the at least one lens comprises at least first and second lenses disposed on an optical path of the illumination light, at least the first and second lenses each being i) tilted, ii) translated or iii) tilted and translated relative to the illumination light.

25. A system as recited in claim 22, wherein the light handling optics comprises a reflective integrator having an output, illumination light exiting the reflective integrator at an output, the at least one lens being on an optical path of the illumination light between the reflective integrator and the spatial light modulator, the at least one lens forming an image of the output of the reflective integrator at the spatial light modulator.

26. A system as recited in claim 18, wherein the light handling optics comprises a reflective integrator, the reflective integrator at least partly compensating for the prism aberrations.

27. A system as recited in claim 26, wherein the reflective integrator has an input aperture at an input end, the input aperture defining an input aperture plane, and the reflective integrator has an output aperture defined by output aperture sides, at least one of the output aperture sides being non-parallel to the input aperture plane.

28. A system as recited in claim 18, wherein image light from the spatial light modulator passes perpendicularly through the third side of the first prism.

29. A system as recited in claim 18, further comprising a second prism disposed proximate the first prism, the first and second prisms forming a prism unit, image light from the spatial light modulator passing through the third and second sides of the first prism to the second prism.

30. A system as recited in claim 29, wherein the image light is transmitted through the second prism.

31. A system as recited in claim 29, wherein the image light is reflected within the second prism.

32. A system as recited in claim 29, further comprising a polarization control element disposed between the first and second prisms.

33. A system as recited in claim 18, further comprising at least one light source to generate the illumination light.

34. A system as recited in claim 33, wherein the light handling optics comprises a reflective integrator disposed to make the illumination light from the at least one light source have a uniform intensity, and at least one relay lens to relay an image of an output of the reflective integrator to the spatial light modulator.

35. A system as recited in claim 34, further comprising at least one folding mirror disposed to fold an optical path taken by the illumination light between the reflective integrator and the spatial light modulator.

36. A system as recited in claim 18, further comprising a projection lens unit, image light from the spatial light modulator being projected by the projection lens unit.

37. A system as recited in claim 18, wherein the spatial light modulator comprises modulator elements lying in an imager plane and the illumination light is incident on the first side along a first axis, the first axis being either parallel to the imager plane or being directed with a component towards the imager plane.

38. A system as recited in claim 18, wherein the first side of the first prism has optical power, the divergence of the illumination light being changed upon passing through the first side of the first prism.

39. A system as recited in claim 18, wherein the first prism is formed of at least a first component and a second component.

40. An illumination system for a spatial light modulator, comprising:
a spatial light modulator comprising an array of modulator elements lying in an imager plane; and
a first prism disposed proximate the spatial light modulator, the first prism having first, second and third sides, the first side forming an angle relative to the imager plane so that, when illumination light enters the first side of the first prism with a direction component directed towards the imager plane, the illumination light is totally internally reflected from the second side of the prism and exits the prism to the spatial light modulator at an angle so that image light is reflected from the spatial light modulator in a direction substantially perpendicular to the imager plane.

41. A system as recited in claim 40, wherein the spatial light modulator comprises an array of rotatable mirrors.

42. A system as recited in claim 40, further comprising an illumination unit to provide the illumination light.

43. A system as recited in claim 42, wherein the illumination unit comprises at least one source of light to generate the illumination light and light handling optics to direct the illumination light from the at least one source of light to the first prism.

44. A system as recited in claim 40, further comprising a prism unit provided proximate the spatial light modulator, the prism unit comprising the first prism and a second prism, image light reflected from the spatial light modulator being transmitted through the first prism to the second prism.
